(19) United States
(12) Patent Application Publication
(10) Pub. No.: US 2008/0245624 A1
(43) Pub. Date: Oct. 9, 2008

(54) Latching device for electro-mechanical actuators

(76) Inventors: Schuyler S. Shaw, Tipp City, OH (US); Paul Rymoff, Bellbrook, OH (US)

Correspondence Address: DELPHI TECHNOLOGIES, INC., M/C 480-410-202, PO BOX 5052, TROY, MI, 48007, US

(21) Appl. No.: 11/784,001

(22) Filed: Apr. 5, 2007

(51) Int. Cl. F16D 65/36; F16H 57/10

(52) U.S. Cl. 188/156; 74/411.5

(57) ABSTRACT

A latching device including a reversibly rotatable drive gear, a reversibly rotatable driven gear meshing with the drive gear, and a cantilever including a latching gear meshing with one of either the drive gear or the driven gear. The cantilever includes an electrically distortable polymeric material configured to distort in response to an applied current to position the latching gear in an intermeshing relationship with both the drive gear and the driven gear, such that the drive gear, driven gear, and latching gear selectively prevent rotational motion of the gear assembly in a predetermined direction. Also, an electromechanical brake assembly including a rotary motor and the latching device, where the gear assembly selectively prevents rotational motion of the rotary motor in a brake-disengaging direction.

### BACKGROUND

This disclosure is directed generally to a latching device for an electromechanical actuator, and more particularly to a device for latching a rotatable shaft via an electrically distortable latch support material.

User actuated, mechanically latched parking brake systems for motor vehicles generally include a brake actuation lever, a brake cable coupling unit, and a brake cable that is tensioned by the brake cable coupling unit as the brake actuation lever is pulled into an engaged position. Such parking brake systems typically include a ratcheting latch mechanism for sustaining the applied braking force and locking the parking brake. This latch mechanism may be, for example, a blocking pawl that drops into a gear in the brake cable coupling unit. Such user actuated, mechanically latched parking brake systems suffer from the drawback that motor vehicle drivers lacking sufficient strength, flexibility, or reach may only partially tension the brake cable, thereby only partially setting the parking brake. In addition, the packaging restraints associated with popular vehicle interior architectures may significantly impede or otherwise prohibit a traditional implementation of such a parking brake system.

Electrically actuated, mechanically latched parking brake systems are known in the art. See, e.g., U.S. Pat. No. 6,942,702 to Klode et al., the entirety which shall be incorporated into this disclosure by reference. Such parking brake systems typically use an electro-mechanical brake actuator to drive a brake pad against a brake rotor or drum, and a dedicated solenoid or accessory motor to set a mechanical latch for sustaining a braking engagement after the motor vehicle has been shut down. This latching mechanism may include, for example, a solenoid-driven latch projection that engages a latch gear disposed on the brake actuator drive shaft. However, parking brake systems incorporating multiple motors, multiple gear systems, and various other accessory parts tend to be relatively expensive, to consume significant power during operation, and to be difficult to package within a vehicle.

Accordingly, it would be desirable to provide a latching device for an electrically actuated braking system that eliminates the need for a latching solenoid or accessory motor, that acts as a parking brake lock mechanism, and that offers a potential for reduced costs, reduced power requirements, and greater packaging flexibility. Additionally, it would be desirable to provide a latching device for a rotatable drive shaft that eliminates the need for conventional solenoids or accessory motors to latch and unlatch the device.

### BRIEF SUMMARY

According to one aspect of the disclosure, a latching device including a reversibly rotatable drive gear, a reversibly rotatable driven gear meshing with the drive gear, and a cantilever including a latching gear meshing with one of either the drive gear or the driven gear. The cantilever includes an electrically distortable polymeric material configured to distort in response to an applied current to position the latching gear in an intermeshing relationship with both the drive gear and the driven gear, such that the drive gear, driven gear, and latching gear selectively prevent rotational motion of the gear assembly in a predetermined direction.

According to another aspect of the disclosure, an electromechanical brake assembly including a rotary motor, a drive gear operatively connected to the rotary motor, a driven gear meshing with the drive gear, and a cantilever including a latching gear meshing with one of the drive gear or the driven gear. The cantilever includes an electrically distortable polymeric material configured to distort in response to an applied current to position the latching gear in an intermeshing relationship with both the drive gear and the driven gear, such that the drive gear, driven gear, and latching gear selectively prevent rotational motion of the rotary motor in a brake-disengaging direction.

Other aspects of the latching device for a electromechanical actuator will become apparent from the following description, the accompanying drawings and the appended claims.

### BRIEF DESCRIPTION OF THE DRAWINGS

FIG. 1 is a front perspective view of one aspect of the disclosed latching device;

FIG. 2 is a partial cross section of the cantilever arm 50 of the device of FIG. 1;

FIG. 3 is a top perspective view of the device shown in FIG. 1, illustrating the device in a unlatched state; and

FIG. 4 is a top perspective view of the device shown in FIG. 1, illustrating the device in a latched state.

### DETAILED DESCRIPTION

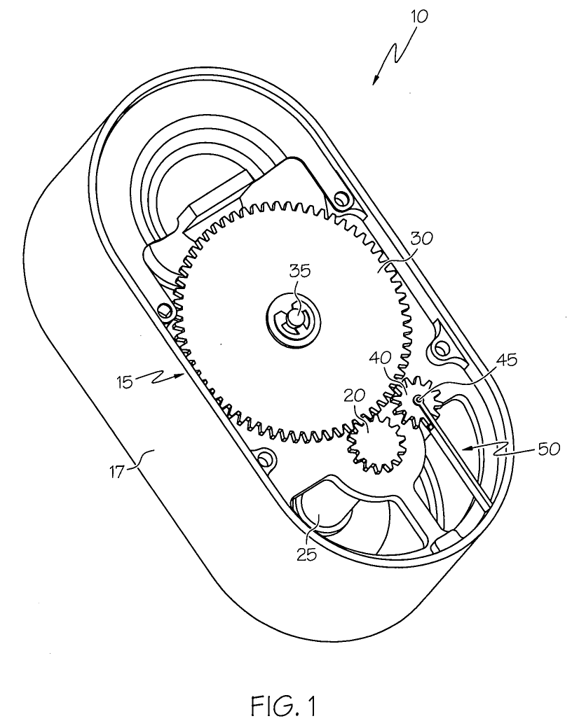

With initial reference to FIG. 1, a latching device, generally denoted 10, may be adapted for mounting on a shaft in an electromechanical actuator, such as the drive shaft of a rotary motor in an electromechanical brake (EMB) assembly. The latching device 10 includes a drive gear 20, a driven gear 30, and a latching gear 40 positioned in a meshing relationship. Latching gear 40 acts as an idler gear in the device's unlatched mode of operation, where drive gear 20 acts to rotate driven gear 30 and gear 40, but acts as a latching gear in the device's latched mode of operation, where the drive gear 20, driven gear 30, and gear 40 intermesh to selectively prevent rotational movement of the gear assembly 20, 30, 40 in a predetermined direction (with respect to a reference gear, which for the purposes of this disclosure shall be drive gear 20). The drive gear 20 may be affixed to the shaft, or affixed to a sleeve 25 rotatably mounted in a housing 15 and adapted to slide over and engage the aforementioned shaft. The driven gear 30 may be rotatably mounted on an axle 35, optionally affixed to an output shaft, or optionally affixed to a sleeve rotatably mounted in the housing 15 and adapted to slide over and engage the aforementioned output shaft. The latching gear 40 may be positioned against one of the drive gear 20 and driven gear 30 in proximity to the other of the drive gear 20 and driven gear 30 by a projecting end of a cantilevered rod 50 or other beam-like structure. An attached end of the cantilever rod 50 may be affixed to the housing 15 or to any other suitable, fixed structure. The latching device is preferably generally contained within a sealable housing 15 comprising a base plate 17 and a cover (not shown) to protect the mechanism from damage, exposure to the environment, etc.

Gears 20, 30, 40 may be characterized as spur gears having straight teeth. Optionally, different diameter spur gears may be meshed to create a gearbox having a particular gear ratio, wherein the speed and torque transmitted to the drive gear 20 may be altered to increase or decrease a desired property transmitted through the driven gear 30. Exact gear ratios can be determined by counting the number of teeth in the drive gear 20 and driven gear 30 and dividing the former by the latter. As illustrated in FIG. 1, the drive gear 20 has fourteen teeth and the driven gear 30 has sixty-four teeth, such that the gear ratio when these two gears are meshed is about 1/4.6 or 1:4.6. Thus, an aspect of the latching device 10 may be adapted for mounting between the drive shaft of a rotary motor and an output shaft connected to a driven part to provide a combination latching mechanism and gearbox. Gearboxes having three or more gears and gearboxes having gear ratios other than the one discussed and illustrated in this particular example may incorporate the latching device 10 without departing from the spirit and scope of the invention.

The cantilever rod 50 includes an actuator portion 51 such as that described in U.S. Pat. No. 6,762,210 to Oguro et al., the entirety which shall be incorporated into this disclosure by reference. Such actuators include polymeric ion exchange materials, which may be known or described using alternative names such as “artificial muscle” material. These materials function as actuators by distorting or otherwise bending in a predictable manner during the application of an activation signal or current. Application of the signal across a pair of opposing electrodes 52 causes a portion of an intermediately disposed ion-exchange resin 53 adjacent to one electrode 52a to swell and a portion adjacent to the other electrode 52b to shrink as solutes and solvents migrate within the resin 53, with the differential swelling and shrinking creating a distortion or bending of the actuator 51. When the activation signal or current is discontinued, the solute and solvent distribution in the ion-exchange resin 53 will revert toward a homogeneous distribution, relieving the distortion and causing a straightening of the actuator 51. Examples of ion-exchange resins suitable for use in forming such actuators include cationinc ion-exchange resins and amphoteric ion-exchange resins. Of these, cationic ion-exchange resins are preferably employed because they permit greater displacement of the projecting end of the cantilever rod 50. Cationic ion-exchange resins employable herein may have, for example, a polyethylene, polystyrene, or fluororesin base modified to include strong acid functional groups. Cation-exchange resins comprising fluororesins having sulfonic acid and/or carboxylic acid functional groups are generally preferred. Water may be used as a polar solvent, and various water-soluble salts may be used to provide a solute to be exchanged with the ion-exchange resin 53. Non-aqueous polar solvents such as glycerol may be added to or used in place of water if the device will be used in sub-freezing or elevated temperature conditions.

The cantilever rod 50 may further include an end cap 54 mounted on the projecting end of the rod 50 and a socket portion 56 for receiving the actuator 51. The end cap 54 may provide a pair of opposed prongs 55 for receiving the latching gear 40 and an axle 45. The end cap 54 is preferably made from a non-conductive polymer so as to direct current through the actuator 51. The socket portion 56 may provide a pair of opposed electrical contacts 57 for supplying current to the opposing electrodes 52, in addition to providing a point of attachment for the actuator 51 to a housing 15 or other structure, and is also preferably made from a non-conductive polymer. The electrodes 52 and ion-exchange resin 53 may additionally be wrapped in an impermeable film 58, such as mylar, to prevent the solvent in the ion exchange resin from evaporating and escaping the actuator 51. The electrodes 52 and ion-exchange resin 53 are preferably wrapped in a gas permeable but liquid impermeable film 58, such as microporous polyethylene, polypropylene, poly(fluorinated)ethylene, and the like, to prevent the solvent in the ion exchange resin from evaporating yet permit any gasses which might be generated through electrolysis, e.g., the hydrolysis of water into hydrogen and oxygen, to diffuse out of the device. The film 58 may serve as the sheath of a replaceable cell for insertion between the end cap 54 and socket portion 56, or may be a component of a fitted sleeve joining end cap 54, actuator 51, and socket portion 56 together.

Latching device 10 acts to prevent rotational movement of the drive gear 20, driven gear 30, and actuator shaft, as well as, optionally, a output shaft, in one of two potential directions of rotation. For example, in the device illustrated in FIGS. 1-3, the latching device will act to prevent rotational movement of the drive gear 20 and actuator shaft in a counter-clockwise (CCW) direction, and to prevent rotational movement of the driven gear 30 as well as any connected output shaft in a clockwise (CW) direction. An alternate configuration including a latching mechanism disposed on the opposite side of drive gear 20 and driven gear 30 would act to prevent rotational motion in the opposite directions. Latching device 10 is used to latch an actuator that experiences a substantial return force during its normal mode of operation. For example, when a brake is applied in a typical EMB assembly, a rotary motor is energized and rotates in an engaging direction to set a brake pad and stop a vehicle in a well known manner. When the motor is de-energized, the EMB assembly will tend to operate in reverse due to the back-drive force of the applied brakes. In normal braking operation such behavior may be disregarded or perhaps even desired, however, in parking brake operation such behavior must be prevented to sustain the braking engagement between the brake pad and brake rotor or drum. The disclosed latching device 10 acts to prevent such reverse rotation until parking brake operation is terminated, as described below. Different applications will become readily apparent to those skilled in the art, and this non-limiting example shall not be interpreted as a disclaimer of alternate applications of the claimed device.

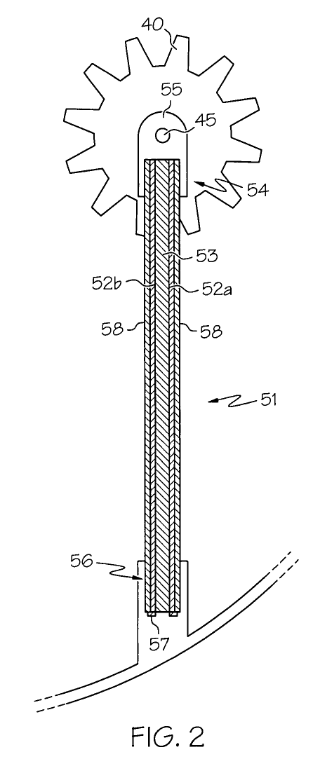

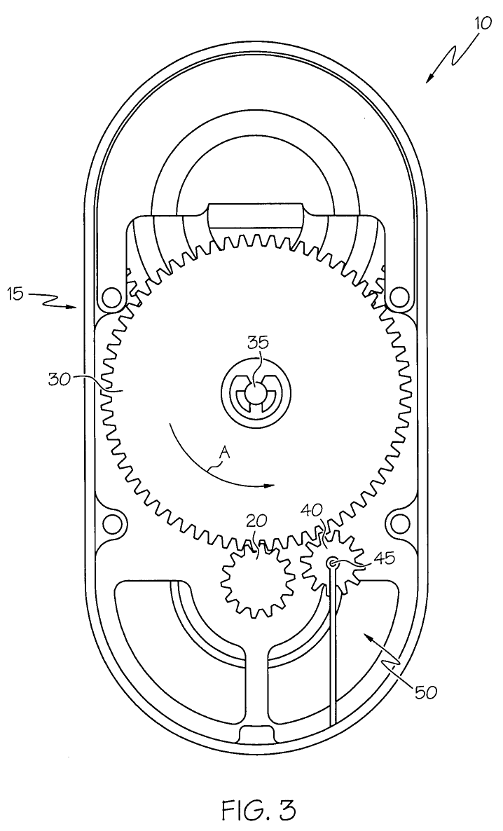

Firstly, the latching device 10 may be installed as a component of an EMB assembly, with the drive gear 20 connected to the drive shaft of a rotary motor, and the driven gear 30 connected to an output shaft and ballscrew for converting rotation into linear force and travel. The motor may thereby bring brake pads into contact with a brake rotor and generate a clamping force in a well known manner. The motor can rotate the drive shaft and drive gear 20 in a CW (clockwise) direction to apply the brake pads to the brake rotor, and rotate the drive shaft and drive gear 20 in a CCW (counterclockwise) direction to withdraw the brake pads from the brake rotor. As illustrated in FIGS. 2 and 3, the latching gear 40 and cantilevered rod 50 are located on the right hand side of the drive gear 20 and driven gear 30, with latching gear 40 idling in engagement with driven gear 30.

Next, an EMB control unit may be triggered to initiate parking brake operation by an external event, such as the selection of a parking brake button when the vehicle is parked. The EMB control unit energizes the rotary motor, causing it to supply a sufficient torque (up to about 90% to about 95% of maximum capability) to the drive shaft and drive gear 20 to apply the brake pads and to hold the vehicle stationary. With reference to FIG. 3, when gears 30 and 40 become stationary, the EMB control unit may subsequently transmit an activation signal or current to the cantilever rod 50 supporting the latching gear 40, causing the actuator 51 to distort or bend generally laterally toward the drive gear 20. Such a distortion urges the latching gear 40 to travel along a circumferential path defined by the periphery of the driven gear 30 toward the drive gear 20. The torque direction provided by the driven gear 30 to the latching gear 40 is shown by arrow A. When the latching gear 40 engages with the drive gear 20, the gears 20, 30, 40 become intermeshed, locking the gear assembly to selectively prevent substantial rotational motion in the predetermined direction.

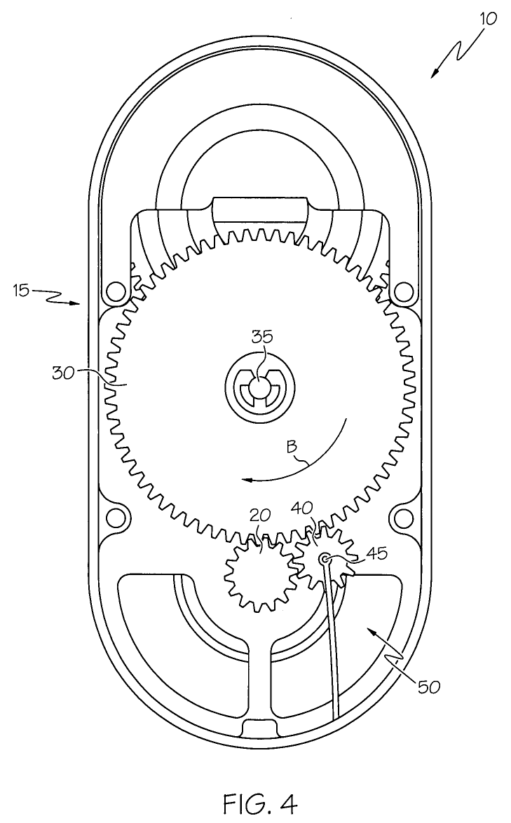

When the gears 20, 30, 40 become intermeshed, a gear rotation detector (not shown) may detect the lack of rotation and transmit a signal to the EMB control unit, and the EMB control unit may respond to that signal by de-energizing the rotary motor, canceling the motor force opposing the back-drive force of the applied brake. With reference to FIG. 4, the torque direction provided by the driven gear 30 to the latching gear 40 will reverse, as shown by the arrow B. Since the drive gear 20 and driven gear 30 typically rotate in opposite directions, the intermeshed latching gear 40 will prevent substantial CCW rotation of the drive gear 20 and “lock” the EMB assembly to sustain a braking engagement. The EMB control unit may simultaneously or subsequently discontinue the activation signal or current transmitted to the cantilever rod 50, which will be held in position by the intermeshed gears 20, 30, 40. Thus, the latching device 10 will sustain brake engagement without continuing to consume electrical power.

The EMB control unit may be triggered to terminate parking brake operation by a follow-on event, such as the selection of a parking brake release button. The EMB control unit energizes the rotary motor, causing it to supply a greater torque (up to about 95% to about 100% of maximum capability) to the drive shaft and the drive gear 20 to further compress the brake pads and generate a CW rotation of the drive gear 20. With reference back to FIG. 3, the torque direction provided by the driven gear 30 to the latching gear 40 reverts, as shown by the arrow A. Because the latching gear selectively prevents rotational movement of the gear assembly 20, 30, 40, the drive gear 20 and driven gear 30 can rotate and push the latching gear 40 away from intermeshing engagement both drive gear 20 and driven gear 30. A residual spring force in the actuator 51 of the cantilevered rod 50 may further urge the latching gear 40 to travel along a circumferential path defined by the periphery of the driven gear 30 away from the drive gear 20. The EMB control unit may then reverse the rotary motor, causing it to generate a CCW rotation of the drive gear 20 to withdraw the brake pads and release the vehicle for movement.

Applications of the disclosed latching device 10 are not limited to the exemplary parking brake system described herein. The disclosed device can be combined with other drives and power take-off components, wherein at least one rotating shaft is operatively controlled by a latch. Application examples in this category make include brakes for motors, transmissions, drive heads, axles and axle drives for vehicles of all descriptions, cable car runaways, conveyor belts, cable winders, machine tools and the like. The disclosed device can also be combined with electromechanical actuators that experience a substantial return force during a normal mode of operation, e.g., an electromechanical winch, to provide a remotely operable latch that that eliminates the need for conventional solenoids or accessory motors to latch and unlatch the device.

Having described the device in detail and by reference to specific aspects thereof, it will be apparent that numerous variations and modifications are possible without departing from the spirit and scope of the invention as defined by the claims.

What is claimed is:

1. A latching device comprising:
a reversibly rotatable drive gear;
a reversibly rotatable driven gear meshing with said drive gear; and
a cantilever including a latching gear meshing with one of said drive gear and said driven gear, wherein said cantilever includes an electrically distortable polymeric material configured to distort in response to an applied current to position said latching gear in an intermeshing relationship with said drive gear and said driven gear;
whereby said drive gear, said driven gear, and said latching gear interoperate to selectively prevent substantial rotational motion of said drive gear in a predetermined direction.

2. The latching device of claim 1, wherein said polymeric material includes an ion exchange resin.

3. The latching device of claim 2, wherein said polymeric material includes a cationic ion exchange resin having a plurality of strong acid functional groups.

4. The latching device of claim 3, wherein said polymeric material includes a fluororesin base material modified to include a plurality of strong acid functional groups selected from a group consisting of sulfonic acid groups, carboxylic acid groups, and combinations thereof.

5. The latching device of claim 2, wherein said cantilever includes a liquid impermeable film at least partially sheathing said ion exchange resin.

6. The latching device of claim 5 wherein said film consists essentially of mylar.

7. The latching device of claim 2, wherein said cantilever includes a gas permeable and water impermeable film at least partially sheathing said ion exchange resin.

8. The latching device of claim 7 wherein said film consists essentially of a material selected from a group consisting of microporous polyethylene, polypropylene, and poly(fluorinated)ethylene film.

9. The latching device of claim 1, wherein said drive gear is operatively connected to a rotary electric motor.

10. The latching device of claim 9, wherein said driven gear is operatively connected to an output shaft.

11. An electromechanical brake assembly comprising:
a rotary motor;
a drive gear operatively connected to said rotary motor;
a driven gear meshing with said drive gear; and
a cantilever including a latching gear meshing with one of said drive gear and said driven gear, wherein said cantilever includes an electrically distortable polymeric material configured to distort in response to an applied current to position said latching gear in an intermeshing relationship with said drive gear and said driven gear;
whereby said drive gear, said driven gear, and said latching gear interoperate to selectively prevent substantial rotational motion of said rotary motor in a brake-disengaging direction.

12. The latching device of claim 11, wherein said polymeric material includes an ion exchange resin.

13. The latching device of claim 12, wherein said polymeric material includes a cationic ion exchange resin having a plurality of strong acid functional groups.

14. The latching device of claim 13, wherein said polymeric material includes a fluororesin base material modified to include a plurality of strong acid functional groups selected from a group consisting of sulfonic acid groups, carboxylic acid groups, and combinations thereof.

15. The latching device of claim 12, wherein said cantilever includes a liquid impermeable film at least partially sheathing said ion exchange resin.

16. The latching device of claim 15 wherein said film consists essentially of mylar.

17. The latching device of claim 12, wherein said cantilever includes a gas permeable and water impermeable film at least partially sheathing said ion exchange resin.

18. The latching device of claim 17 wherein said film consists essentially of a material selected from a group consisting of microporous polyethylene, polypropylene, and poly(fluorinated)ethylene film.
